(19) United States
(12) Patent Application Publication
(10) Pub. No.: US 2004/0006399 A1
(43) Pub. Date: Jan. 8, 2004

(54) Method and system for managing and monitoring an organization

(76) Inventor: Alan L. Klein, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/603,681

(22) Filed: Jun. 25, 2003

Related U.S. Application Data
(60) Provisional application No. 60/391,732, filed on Jun. 26, 2002.

(51) Int. Cl. G05B 13/02

(52) U.S. Cl. 700/31

(57) ABSTRACT

A method and system for managing and monitoring an organization. The organization includes goals, programs, and resources. The organization also includes a value chain, which represents how the organization conducts itself and produces value. The value chain consists of value chain components that each relate to an aspect of the organization. The invention allows the goals, programs, and resources to be linked to each other and to the value chain and value chain components.

### CROSS-REFERENCES TO RELATED APPLICATIONS

This patent application claims priority to United States Provisional Patent Application No. 60/391,732 filed on Jun. 26, 2002.

### FIELD OF THE INVENTION

The subject invention relates to a method and system of managing and monitoring an organization, such as a business enterprise, by linking and analyzing goals, programs, and resources of the organization as a value chain of the organization.

### BACKGROUND OF THE INVENTION

Organizations, particularly business organizations, typically set a number of goals to achieve over a course of time. These goals may target improved profitability, sales, efficiency, safety, quality, etc. These goals are typically essential to the long-term viability, profitability, and survival of the organization.

Organizations also usually have a number of programs, or projects, that are being implemented. These programs may include, e.g., an upgrade of a machining line, implementing a new accounting system, improving ergonomics of an operation, launching a product into a new market, etc. Ideally, these programs are implemented to support one or more of the goals of the organization. Often, however, and particularly in larger organizations, this is not the case. Programs may be executed without any clear benefit to the organization or tie to the goals of the organization. Multiple programs having the same objective may be executed independently by different groups within the organization, thus reducing efficiency of the organization.

Organizations also use resources (e.g., employees, contractors, and suppliers) to implement corporate programs and to achieve desired goals. Typically, as organizations become larger, more decentralized, and rely more extensively on external suppliers, it is often difficult to effectively manage and deploy resources.

In many organizations, reporting on the progress of the goals, programs, and resources is a labor intensive progress fraught with difficulties, especially when users reside in different geographical locations or even in different companies. For example, data may be spread out over numerous departments and groups within the organization. Additionally, various managers may use different methodologies of reporting across the organization and will often put a positive “spin” on the data being reported.

Many organizations do not have a centralized way of analyzing and managing all the goals, programs, and resources of the organization. This may often lead to projects being executed which do not bring real value to the organization, goals that are set but never achieved, resources that have little accountability, and an overall inefficient and/or ineffective enterprise.

The subject invention is aimed at one or more of the problems discussed above.

### BRIEF SUMMARY OF THE INVENTION

In a first aspect of the present invention, a method of monitoring and managing an organization is provided. The organization includes a plurality of goals, a plurality of programs to attain the plurality of goals, a plurality of resources to implement the plurality of programs. The method includes the step of registering at least one of one of the goals, one of the programs, and one of the resources. The registered one of one of the goals, one of the programs and one of the resources has at least one characteristic. The method also includes the step of establishing a value chain. The value chain has at least one value chain component representing an aspect of the organization. Each value chain component has at least one component characteristic. The method further includes the steps of assigning the registered one of one of the goals, one of the programs, and one of the resources to the least one value chain component and establishing a value of the at least one component characteristic of the at least one value chain component. The value is derived from the characteristic of the registered one of one of the goals, one of the programs, and one of the resources.

In a second aspect of the present invention, a method of monitoring and managing an organization is provided. The organization has a plurality of goals and a plurality of programs to attain the plurality of goals. The method includes the steps of registering the plurality of goals and registering the plurality of programs. Each goal has at least one characteristic. Each program has at least one characteristic. The method also includes the steps of associating each program to at least one of the goals and establishing a value chain. The value chain has at least one value chain component representing an aspect of the organization. Each value chain component has at least one component characteristic. The method further includes the steps of assigning at least one of one of the plurality of goals and one of the plurality of programs to each value chain component and establishing a value of the at least one component characteristic of each value chain component. The value is derived from the characteristic of the at least one of one of the plurality of goals and one of the plurality of programs assigned to the value chain component.

In a third aspect of the present invention, the present invention provides a method of managing and monitoring an organization. The organization has a plurality of goals, a plurality of programs to attain the plurality of goals, and a plurality of resources to implement the plurality of programs and/or attain the plurality of goals. The method comprises the steps of registering the plurality of goals, each goal having at least one characteristic, registering the plurality of programs, each program having at least one characteristic, and associating each program to at least one of the goals. The method further comprises the steps of registering the plurality of resources. Each resource has at least one characteristic. At least one resource is associated with one of one of the plurality of goals and one of the plurality of programs. The method further includes the step of establishing a value chain. The value chain has at least one value chain component representing an aspect of the organization, each value chain component having at least one component characteristic. The method may also include the steps of assigning at least one of one of the plurality of goals, one of the plurality of programs, and one of the plurality of resources to each value chain component, establishing a value of the at least one component characteristic of each value chain component, the value derived from the characteristic of the at least one of one of the plurality of goals, one of the plurality of programs, and one of the plurality of resources assigned to the value chain component.

The invention also provides a computer based system for monitoring the organization, the system comprising a database for storing data related to the organization and a controller coupled to the database.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1A is a block diagram illustrating a method of monitoring an organization, according to an embodiment of the present invention;

FIG. 1B is a block diagram illustrating a method of monitoring an organization, according to another embodiment of the present invention;

FIG. 1C is a block diagram illustrating a method of monitoring an organization, according to a still another embodiment of the present invention;

FIG. 2 is a block diagram showing components of a computer based system for implementing the method of FIG. 1;

FIG. 3A is a view of a customizable summary portal screen available from a user interface of the computer based system of FIG. 2;

FIG. 3B is a view of a program detail report available from the user interface;

FIG. 3C is a view of a goal detail report available from the user interface;

FIG. 3D is a view of a goal palette screen available form the user interface; and

FIG. 4 is a block diagram showing an abstract view of the organization.

### DETAILED DESCRIPTION OF THE INVENTION

Referring to the Figures, wherein like numerals indicate like or corresponding parts throughout the several views, a method 10, 210, 310 of monitoring an organization 100 and associated computer based system 30 is disclosed.

With reference to FIG. 4, the organization 100 may include a plurality of goals 102, a plurality of programs 104, and/or a plurality of resources 106. As discussed below, the goals 102, programs 104, and resources 106 may be interconnected. Furthermore, the goals 102, programs, 104, and resources 106 may be associated with or assigned to a value chain (see below).

The goals 102 are quantitative targets that the organization 100 desires to achieve. The goals 102 may be financial, such as, “increase revenue by $2 million,” or, “cut material costs by $250 thousand.” Alternatively, the goals 102 may be performance related, such as, “decrease order-to-delivery cycle time by 3 days,” or, “increase customer satisfaction by 2 points”.

Each goal 102 has at least one characteristic. In the illustrated embodiment, characteristics of the goal 102 may include a goal status and a goal value. Furthermore, there may be several types of goal statuses and goal values. The types of goal statuses include, but are not limited to, an overall goal status, a current goal status, and a projected goal status. The types of goal values may include, but are not limited to, a target goal value and an actual goal value. In addition, there may be several instances of the actual goal value over time. For example, the actual goal value may be $1.1 million on January 1st, and $1.6 million on June 30th.

The programs 104 are typically projects or strategic initiatives that are executed in order to attain the plurality of goals 102. As with the goals 102, each program 104 has at least one characteristic. Likewise, in the illustrated embodiment, characteristics of the program 104 include a program status and a program value. The types of program statuses may include, but are not limited to, an overall program status, a current program status, a projected program status, a program scope status, a program budget status, a program schedule status, a program resource status, a program benefit status, and a program business value status. The types of program values may include, but are not limited to, a program scope, a program budget, a program schedule, a program resource, a program benefit (enterprise goal), and a program business value. Additionally, there may be several instances of each program status and program value over time.

Resources 106 are persons, e.g. employees, contractors, etc., and groups to implement the plurality of programs 104. Each resource 106 may have at least one characteristic. In the illustrated embodiment, characteristics of the resource 104 may include a resource status or a resource value. The types of resource statuses may include, but are not limited to, overall performance and projected performance. The types of resource values may include, but are not limited to, capacity and utilization.

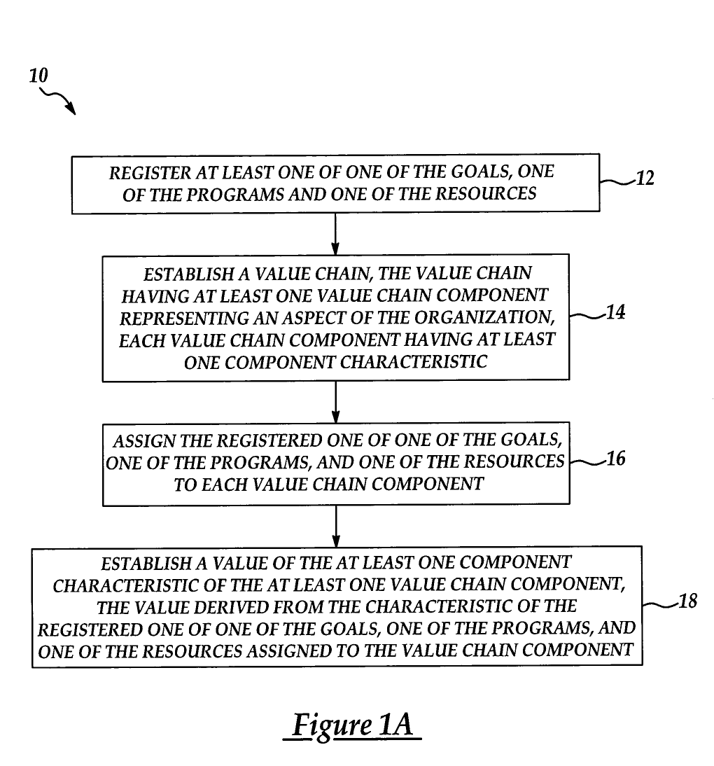

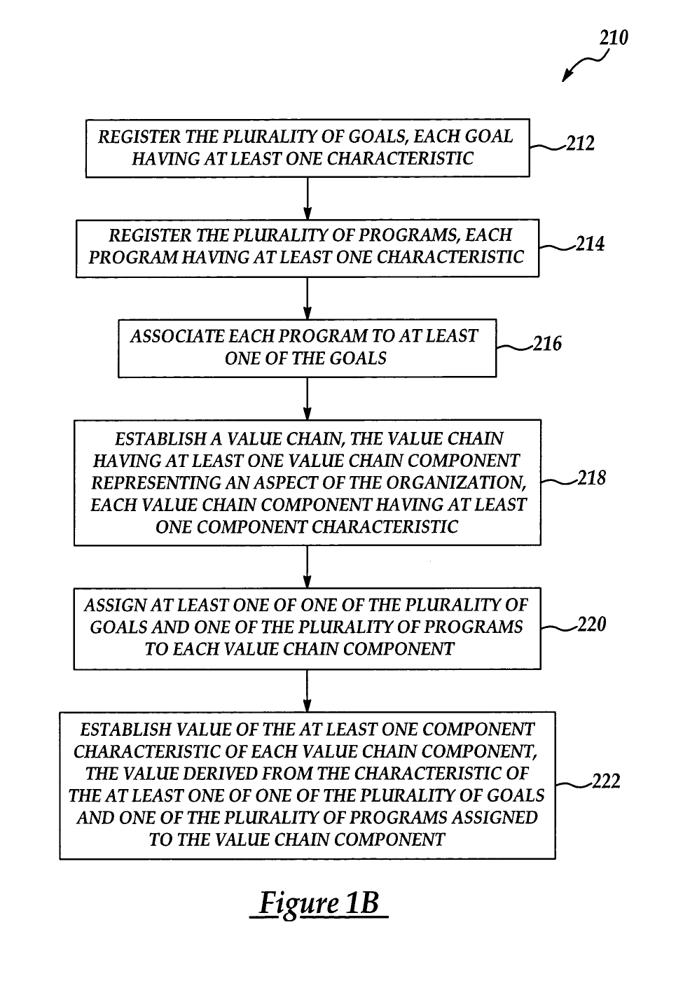

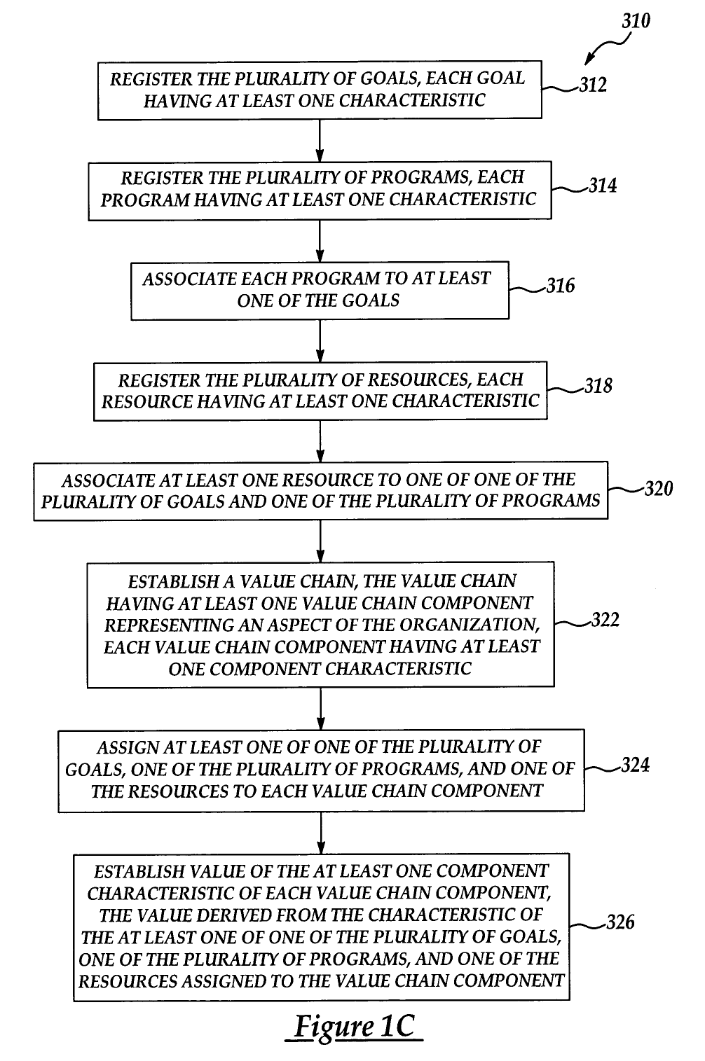

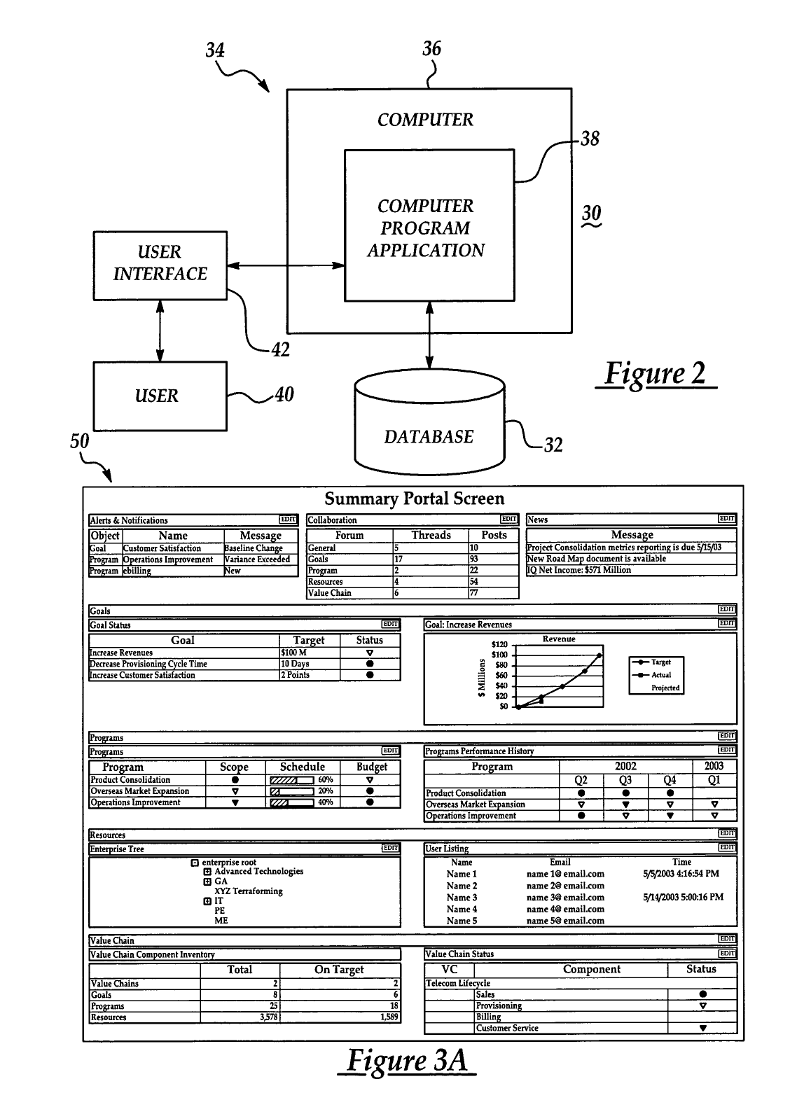

With reference to FIG. 1A in one embodiment of the present invention, in a first step 12 at least one of one of the goals, one of the programs, and one of the resources are registered. The registered one of one of the goals, one of the programs and one of the resources has at least one characteristic. In a second step 14, a value chain is established. The value chain includes at least one value chain component representing an aspect of the organization. Each value chain component has at least one component characteristic. In a third step 16, the registered one of one of the goals, one of the programs, and one of the resources is assigned to the least one value chain component. In a fourth step, a value of the at least one component characteristic of the at least one value chain component is established. The value is derived from the characteristic of the registered one of one of the goals, one of the programs, and one of the resources.

With reference to FIG. 1B, in another embodiment of the present invention, in a first step 212 the plurality of goals are registered. Each goal has at least one characteristic. In a second step 214, the plurality of programs are registered. Each program has at least one characteristic. In a third step 216, each program is associated to at least one of the goals. In a fourth step 218 a value chain is established. The value chain includes at least one value chain component representing an aspect of the organization. Each value chain component has at least one component characteristic. In a fifth step 220, at least one of one of the plurality of goals and one of the plurality of programs is assigned to each value chain component. In a sixth step 222, a value of the at least one component characteristic of each value chain component is established. The value is derived from the characteristic of the at least one of one of the plurality of goals and one of the plurality of programs assigned to the value chain component.

With reference to FIG. 1C, in still another embodiment, in a first step 312, the plurality of goals are registered. In the computer based system 30 detailed below, this step is performed by storing the goal 102 and its characteristics in a database 32.

In one embodiment, the method 10, 210, 310 may also include the step of establishing a level of the goal status. In the illustrated embodiment, the level of the goal status may be one of the following: “way over target”, “over target”, “on target”, “under target”, or “way under target”. However, it should be appreciated that other nomenclature for the level of the goal status will be apparent to one skilled in the art. Establishing the level of the goal status is done manually by a user 40 or automatically by the system 30. Each type of goal status may have a level established relating to that particular type.

The method 10, 210, 310 may further include the step of establishing an amount of the goal value. Each type of goal value may have an amount established relating to that particular type. For example, the target goal value may be $2 million and the actual goal value may be $2.3 million.

Returning to FIG. 1C, in a second step 314, the plurality of programs 104 are registered. With the computer based system 30 of the illustrated embodiment, this step is performed by storing the program and its characteristics in a database 32.

The step of establishing a level of the program status may also be included in the method 10, 210, 310. In the illustrated embodiment, the level of the program status may be one of the following: “way over target”, “over target”, “on target”, “under target”, or “way under target”. Establishing the level of the program status may be done manually by a user 40 or automatically by the system 30 using information from other systems (not shown) and other databases (not shown). Each type of program status may have a level established relating to that particular type.

The method 10, 210, 310 may also include the step of establishing an amount of the program value. Each type of program value may have an amount established relating to that particular type.

Returning to FIG. 1C, in a third step 316, each program is associated to at least one of the goals. This step 316 links the program 104 to the goal or goals 102 that the program 104 is targeted to help achieve. However, it should be realized that goals need not be associated with programs. The programs and goals can exist autonomously from each other.

Returning to FIG. 1C, in a fourth step 318, the plurality of resources 106 are registered. With the computer based system 30 of the illustrated embodiment, this step is performed by storing the program and its characteristics in a database 32.

The method 10, 310 may also include the steps of establishing a level of the resource status and establishing an amount of the resource value. As with the goals 102 and the programs 104, establishing the level of the resource status and the amount of the resource value may be accomplished manually by a user 40 or automatically by the system 30.

In a fifth step 320, at least one resource 106 is associated to each program 104. This step 320 links the resources 106 to the program or programs 104 that the resources 106 are working on.

In addition, the at least one resource 106 may be associated with the at least one goal 102. This is to link the goal or goals 102 to the resource or resources 106 that are accountable for the goal or goals 102.

In a sixth step 322, a value chain 108 is established. In one aspect of the present invention, the value chain 108 represents how an organization 100 conducts itself and produces value. The value chain 108 has at least one value chain component representing an aspect of the organization 100. Value chains 108 and their associated value chain components will vary between industries and between companies within an industry. For example, in a manufacturing industry, a value chain 108 could be known as a “Product Life Cycle”. The associated value chain components might be known as “Design”, “Production”, “Sales”, and “Service”. A non-business example could be a religious organization, where the value chain 108 is “Elements of Faith”. The associated value chain components could be “Learning”, “Practicing”, and “Fostering”.

Each value chain component has at least one component characteristic. In the illustrated embodiment, characteristics of the value chain component include a component status and a component value. Establishing a level of the component status and establishing an amount of the component value are steps of the illustrated embodiment. The establishment of the level of the component status or the amount of the component value may be performed manually by the user 40 or automatically by the system 30.

In a seventh step, at least one of one of the plurality of goals 102 and one of the plurality of programs 104 and one of the plurality of resources 106 is assigned to each value chain component. These important links allow each value chain component to become associated with the goals 102 and/or programs 104 and/or resources 106 that the component is a part of and is responsible for. By examining the value chain components with goals 102 and/or programs 104 and/or resources 106 linked, the user 40 is provided with an alternate “view” of the organization 100 that more closely resembles how the organization 100 functions and strives to achieve its goals 102.

In one aspect of the invention, at least one goal or at least one program may be assigned to each value chain component. For example, an entire value chain, including each value chain component, may be linked only to goals. Alternatively, the value chain could be linked only to programs. In a second aspect of the invention, at least one goal, at least one program, or at least one resource may be assigned to each value chain component.

The combination of goals 102, programs 104, and resources 106 assigned to each value chain component will vary depending on the goals 102, programs 104, resources 106, and value chain components. For example, two goals 102 may be the only things assigned to one value chain component. Alternatively, the value chain component could be linked to only two programs 104. However, it is possible for a value chain component to have several goals 102, several programs 104, and several resources 106 assigned to it.

In an eighth step 326 a value of the at least one component characteristic of each value chain component is established. The value is derived from the characteristic of the at least one of one of the plurality of goals 102 and one of the plurality of programs 104 and one of the resources 106 assigned to the value chain component. Additionally, the characteristic of the plurality of resources 106 assigned to the component may also be used to derive the value of the component. Establishing the value of each component characteristic may be performed manually by the user 40 or automatically by the system 30.

The method 10, 210, 310 may also include the step of reporting at least one of the goal characteristics, the program characteristics, the resource characteristics, and the component characteristics. This reporting gives the user critical information about the organization 100, thus allowing the user to make effective decisions regarding the direction of the organization 100.

The computer based system 30 may be used to implement the method 10. However, those skilled in the art will recognize that the method 10 could be executed with a different apparatus with alternative components or without the system 30 altogether.

The computer based system 30 includes a database 32 for storing data related to the organization, including the goals, programs, and resources, and their associated characteristics. A controller 34 is coupled to the database 32. The controller 34 is adapted to run a computer program application 38. In one embodiment, the controller 34 is a stand-alone computer 36 operable by the user 40 through the user interface 42. The user interface 42 allows the user 40 to enter data into the controller 34 and receive information from the controller 34. Alternatively, the user interface 42 may be implemented across a network, such as the Internet. Multiple users 40 may access the system 30 and use the system 30 concurrently. In addition, one user 40 may have different access abilities to the system 30 than another user 40.

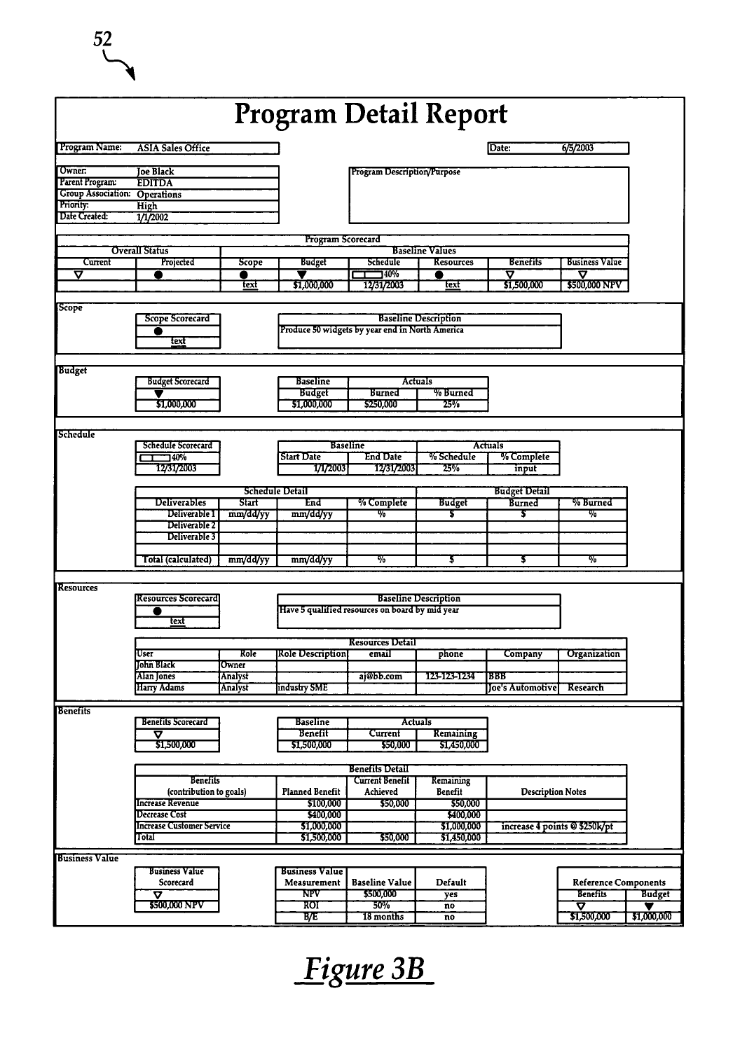

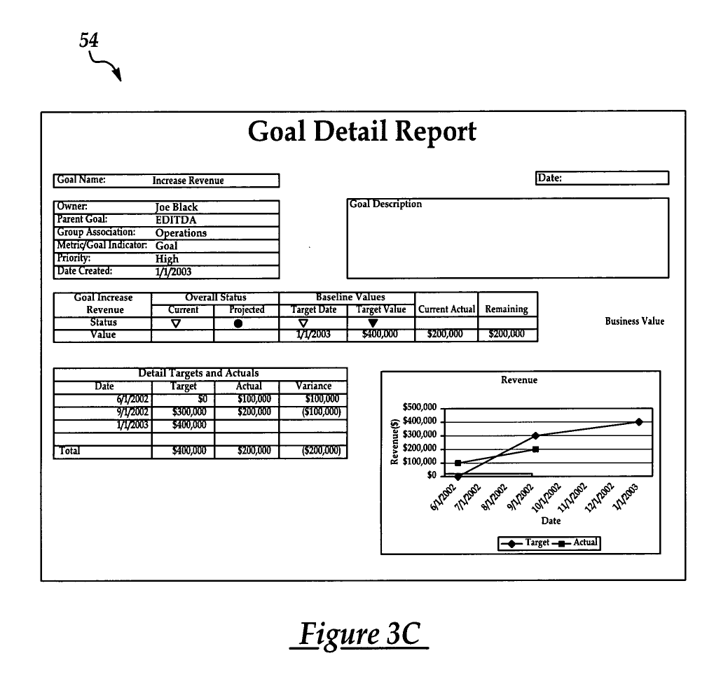

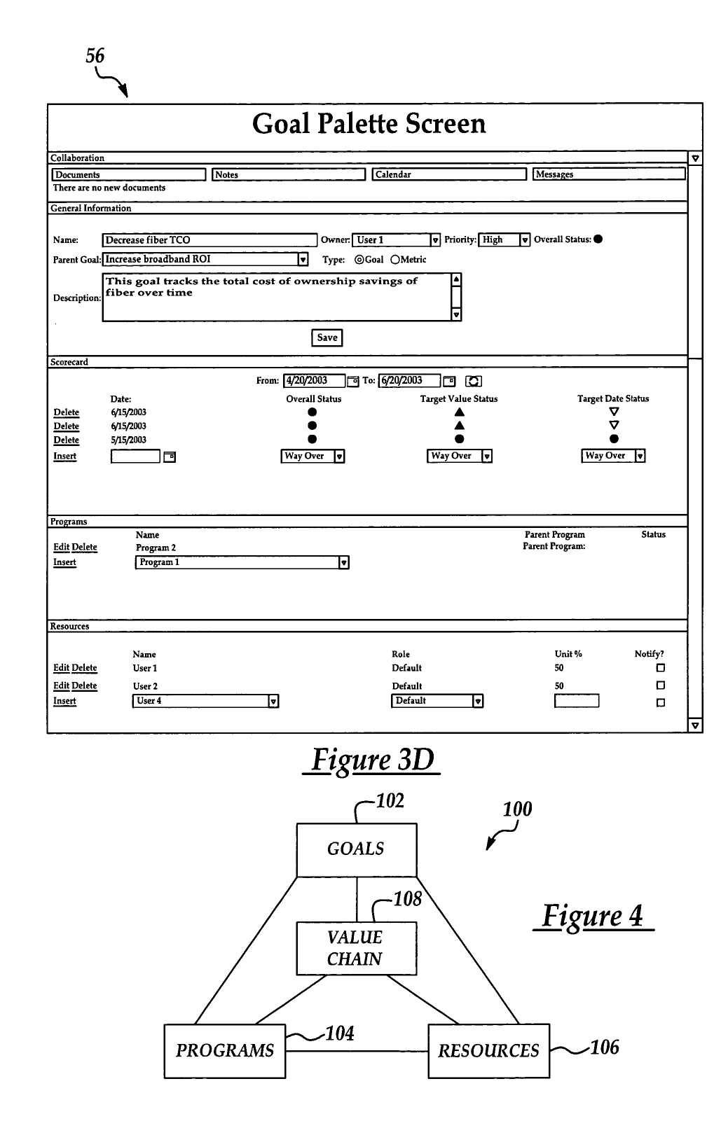

Referring to FIG. 3A, in the illustrated embodiment, the user interface 42 can display a summary screen 50 showing various aspects of the organization 100. This summary screen 50 is configurable by the user 50. In the illustrated embodiment, the summary screen 50 includes listings of the goals 102, programs 104, resources 106, and value chain components of the organization, as well as the characteristics of the goals 102, programs 104, resources 106, and value chain components. Further, the summary screen 50 may provide access to organization 100 news, information, and discussions.

Referring now to FIG. 3B, the user interface 42 of the illustrated embodiment provides a program detail report 52. The program detail report 52 allows the user 40 to view program statuses and values. A similar goal detail report 54 is shown in FIG. 3C, allowing the user 40 to view goal statuses and values.

Now referring to FIG. 3D, the user interface 42 allows the user 42 to view a goal palette 56. The goal palette 56 shows information about the goal, goal statuses, and programs and resources associated to the goal. It should be recognized that additional or modified screens and reports may be presented to the user 40 through the user interface 42.

Obviously, many modifications and variations of the present invention are possible in light of the above teachings. The invention may be practiced otherwise than as specifically described within the scope of the appended claims.

What is claimed is:

1. A method of monitoring and managing an organization, the organization having a plurality of goals, a plurality of programs to attain the plurality of goals, a plurality of resources to implement the plurality of programs, said method comprising the steps of:
registering at least one of one of the goals, one of the programs, and one of the resources, the registered one of one of the goals, one of the programs and one of the resources having at least one characteristic;
establishing a value chain, the value chain having at least one value chain component representing an aspect of the organization, each value chain component having at least one component characteristic;
assigning the registered one of one of the goals, one of the programs, and one of the resources to the least one value chain component; and,
establishing a value of the at least one component characteristic of the at least one value chain component, the value derived from the characteristic of the registered one of one of the goals, one of the programs, and one of the resources.

2. A method of monitoring and managing an organization, the organization having a plurality of goals and a plurality of programs to attain the plurality of goals, said method comprising the steps of:
registering the plurality of goals, each goal having at least one characteristic;
registering the plurality of programs, each program having at least one characteristic;
associating each program to at least one of the goals;
establishing a value chain, the value chain having at least one value chain component representing an aspect of the organization, each value chain component having at least one component characteristic;
assigning at least one of one of the plurality of goals and one of the plurality of programs to each value chain component;
establishing a value of the at least one component characteristic of each value chain component, the value derived from the characteristic of the at least one of one of the plurality of goals and one of the plurality of programs assigned to the value chain component.

3. A method as set forth in claim 2 wherein the step of assigning at least one of one of the plurality of goals and one of the plurality of programs to each value chain component includes assigning at least two of the goals to each value chain component.

4. A method as set forth in claim 2 wherein the step of assigning at least one of the one of plurality of goals and one of the plurality of programs to each value chain component includes assigning at least two of the programs to each value chain component.

5. A method as set forth in claim 2 wherein the step of assigning at least one of one of the plurality of goals and one of the plurality of programs to each value chain component includes assigning at least one of the goals and at least one of the programs to each value chain component.

6. A method as set forth in claim 2 wherein the characteristic of at least one goal includes a goal status, said method further comprising the step of establishing a level of the goal status.

7. A method as set forth in claim 2 wherein the characteristic of at least one goal includes a goal value, said method further comprising the step of establishing an amount of the goal value.

8. A method as set forth in claim 2 wherein the characteristic of at least one program includes a program status, said method further comprising the step of establishing a level of the program status.

9. A method as set forth in claim 2 wherein the characteristic of at least one program includes a program value, said method further comprising the step of establishing an amount of the program value.

10. A method as set forth in claim 2 wherein the at least one component characteristic includes a component status, the step of establishing a value of the component characteristic including the step of establishing a level of the component status.

11. A method as set forth in claim 2 wherein the at least one component characteristic includes a component value, the step of establishing a value of the component characteristic including the step of establishing an amount of the component value.

12. A method as set forth in claim 2 wherein the step of establishing a value of the component characteristic includes assigning the value from input of a user.

13. A method as set forth in claim 2 further comprising the step of reporting at least one of the goal characteristics, the program characteristics, and the component characteristics.

14. A method of monitoring and managing an organization, the organization having a plurality of goals, a plurality of programs to attain the plurality of goals, a plurality of resources to implement the plurality of programs, said method comprising the steps of:
registering the plurality of goals, each goal having at least one characteristic;
registering the plurality of programs, each program having at least one characteristic;
associating each program to at least one of the goals;
registering the plurality of resources, each resource having at least one characteristic;
associating at least one resource to each program;
establishing a value chain, the value chain having at least one value chain component representing an aspect of the organization, each value chain component having at least one component characteristic;
assigning at least one of one of the plurality of goals, one of the plurality of programs, and one of the plurality of resources to each value chain component;
establishing a value of the at least one component characteristic of each value chain component, the value derived from the characteristic of the at least one of one of the plurality of goals, one of the plurality of programs, and one of the plurality of resources assigned to the value chain component.

15. A method as set forth in claim 14 wherein the step of assigning at least one of the plurality of goals, one of the plurality of programs, and one of the plurality of resources to each value chain component includes assigning at least two of the goals to each value chain component.

16. A method as set forth in claim 14 wherein the step of assigning at least one of one of the plurality of goals, one of the plurality of programs, and one of the plurality of resources to each value chain component includes assigning at least two of the programs to each value chain component.

17. A method as set forth in claim 14 wherein the step of assigning at least one of one of the plurality of goals, one of the plurality of programs, and one of the plurality of resources to each value chain component includes assigning at least two of the resources to each value chain component.

18. A method as set forth in claim 14 wherein the step of assigning at least one of one of the plurality of goals, one of the plurality of programs, and one of the plurality of resources to each value chain component includes assigning at least one of the goals, at least one of the programs, and at least one of the resources to each value chain component.

19. A method as set forth in claim 14 wherein the characteristic of at least one goal includes a goal status, said method further comprising the step of establishing a level of the goal status.

20. A method as set forth in claim 14 wherein the characteristic of at least one goal includes a goal value, said method further comprising the step of establishing an amount of the goal value.

21. A method as set forth in claim 14 wherein the characteristic of at least one program includes a program status, said method further comprising the step of establishing a level of the program status.

22. A method as set forth in claim 14 wherein the characteristic of at least one program includes a program value, said method further comprising the step of establishing an amount of the program value.

23. A method as set forth in claim 14 wherein the characteristic of at least one resource includes a resource status, said method further comprising the step of establishing a level of the resource status.

24. A method as set forth in claim 14 wherein the characteristic of at least one resource includes a resource value, said method further comprising the step of establishing an amount of the resource value.

25. A method as set forth in claim 14 wherein the at least one component characteristic includes a component status, the step of establishing a value of the component characteristic including the step of establishing a level of the component status.

26. A method as set forth in claim 14 wherein the at least one component characteristic includes a component value, the step of establishing a value of the component characteristic including the step of establishing an amount of the component value.

27. A method as set forth in claim 14 wherein the step of establishing a value of the component characteristic includes assigning the value from input of a user.

28. A method as set forth in claim 14 further comprising the step of reporting at least one of the goal characteristics, the program characteristics, the resource characteristics, and the component characteristics.

29. A computer based system for monitoring and managing an organization, the organization having a plurality of goals, a plurality of programs to attain the plurality of goals, a plurality of resources to implement the plurality of programs, said system comprising:
a database for storing data related to the organization, including the goals, programs, and resources;
a controller coupled to the database for receiving input from a user and responsively registering the plurality of goals, each goal having at least one characteristic, registering the plurality of programs, each program having at least one characteristic, associating each program to at least one of the goals, registering the plurality of resources, associating at least one resource to each program, establishing a value chain, the value chain having at least one value chain component representing an aspect of the organization, each value chain component having at least one component characteristic, assigning at least one of one of the plurality of goals, and one of the plurality of programs, and one of the plurality of resources to each value chain component, and for establishing a value of the at least one component characteristic of each value chain component, the value derived from the characteristic of the at least one of one of the plurality of goals, the plurality of programs, and the plurality of resources assigned to the value chain component.

30. A computer based system as set forth in claim 29, wherein the controller is operatively connected to a user interface for allowing the user to input data to and receive data from the controller.
